(19) United States
(12) Patent Application Publication
(10) Pub. No.: US 2010/0145588 A1
(43) Pub. Date: Jun. 10, 2010

(54) CREEPING PROCESS

(75) Inventors: Michael REUSCHEL, Ottersweier (DE); Frank BAST, Buehlertal (DE)

Correspondence Address: SIMPSON & SIMPSON, PLLC, 5555 MAIN STREET, WILLIAMSVILLE, NY, 14221-5406, US

(73) Assignee: LUK LAMELLEN UND KUPPLUNGSBAU BETEILIGUNGS KG, Buehl (DE)

(21) Appl. No.: 12/627,131

(22) Filed: Nov. 30, 2009

(30) Foreign Application Priority Data
Dec. 4, 2008 (DE) 102008060583.2

(51) Int. Cl. G06F 19/00; F16H 61/20

(52) U.S. Cl. 701/70; 477/114

(57) ABSTRACT

A process and apparatus for controlling the creeping process of a motor vehicle. The nominal creeping speed can be adapted.

### FIELD OF THE INVENTION

The invention relates to a process for controlling the creeping motion of a motor vehicle, as well as an apparatus for controlling the creeping motion of a motor vehicle.

In vehicles with automated manual-shift transmission, for instance parallel shift transmission—also called twin clutch transmission—it is common to provide a creeping motion function. The creeping motion function brings the vehicle into a creeping motion as soon as the prerequisites for the creeping motion are fulfilled, so that, for instance, comfortable slow motion is assisted without actuation of the accelerator pedal. Additionally, for an activated creeping motion function, a certain transmitted clutch-torque is set, for instance, which ranges from 10 to 14 Nm in magnitude. The transmitted clutch-torque is normally limited at a maximum value, approximately 30 Nm; thus, it ensures that the vehicle executes creeping motion only at low speeds, hence it remains particularly slow. The internal combustion engine is normally controlled such that it can generate the intended clutch torque at the clutch.

The driver must operate the brake pedal in order to slow down or stop the creeping motion.

The creeping motion of the vehicle can occur, depending on the selected gear—both in the forward as well as in reverse direction, and assist the driver when starting up or maneuvering. With regard to parallel shift transmissions or controls for parallel shift transmissions of the prior art, it is known that the creeping torque is set at the clutch. Thus, the creeping motion function is activated as soon as the vehicle satisfies the conditions for creeping, thus, in particular when the engine, a forward or a reverse gear is selected and the accelerator pedal is not activated.

### BACKGROUND OF THE INVENTION

To date, creeping motion functions are known which can set a fixed nominal creeping speed for instance during a speed-controlled creeping process or which can set the nominal creeping speed depending upon a default reference value such as the brake pedal, as described in DE 102 25 263 A1. This can lead to a situation in which the driving speed caused by the traffic flow is lower than a fixed nominal creeping speed provided by the software; thus always forcing the driver to activate the brake in order to reduce the nominal creeping speed. Should this decreased speed be maintained versus a period then the driver must activate the brake more forcefully during this period in order to achieve further reduction of speed so that the nominal creeping speed is likewise further decreased.

It is a disadvantage, however, that no adaptation is made at driver's desire. The driver must therefore retain the foot on the brake pedal, always intervene, and undertake an appropriate correction in the one or other direction.

### BRIEF SUMMARY OF THE INVENTION

The slow driving range is often covered by a creeping motion functionality for reliable and comfortable operation of twin clutch transmission, thus called parallel shift transmission of a vehicle in which at least one clutch guarantees an Automated Clutch function in the drive train.

The creeping motion function, on the other hand, must satisfy the comfort requirements of the driver. The torque build-up may not occur too quickly so that the vehicle does not accelerate too fast. On the other hand, it must be optimally adapted to the operating situation so that the vehicle can be driven also in special situations like stop-and-go traffic.

A creeping motion function to date for instance provides for a constant creeping torque or a constant creeping speed. This fixed default can be insufficient depending upon the operating state, since the driver expects something different in this case. Therefore, especially in the rush hour traffic, with changing speeds—in particular, in the slow driving range—a possibly optimum adaptation of the vehicle to this situation is expected.

Based on the latter, the task of the invention is to provide a process for controlling an automated manual-shift transmission for a vehicle, which provides a creeping motion function that allows the driver to select the nominal creeping speed comfortably.

According to the invention, the nominal creeping speed during the creeping process or just upon an instantaneous interruption of the creeping process is decreased depending on a braking activity of a brake pedal.

In an example embodiment, a transient interruption of the creeping process can occur by means of a transient interruption via brief actuation of the accelerator pedal.

In an example embodiment, the nominal creeping speed is increased during the creeping process or upon a transient interruption of the creeping process depending on a driving pedal activity.

In an example embodiment, for a period of 1 second to 5 minutes, 1 minute can be considered as a transient interruption in this case.

In an example embodiment, the nominal creeping speed during the creeping process or during a transient interruption of the creeping process whilst actuating the brake is decreased by a default reduction value.

Alternatively, in an example embodiment, the nominal creeping speed is decreased by a default reducing value during the creeping process or during a transient interruption of the creeping process whilst actuating the brake.

In an example embodiment, the brake pedal activity is determined from the number of brake actuations during a default measuring-period during an uninterrupted creeping process or during a transient interruption of the creeping process.

Alternatively, in an example embodiment, the brake pedal activity is the fraction of the time during which the brake is activated during a default measuring-period relative to the default measuring-period during an uninterrupted creeping process or during a transient interruption of the creeping process.

Alternatively, in an example embodiment, the brake pedal activity is determined from a time integral versus the brake torque or the brake pressure from the beginning to the end of a default measuring-period during an uninterrupted creeping process or during a transient interruption of the creeping process.

In an example embodiment, the nominal creeping speed is decreased by a default reducing-value weighted with the brake pedal activity.

In an example embodiment, the reducing value lies between 0.01 kilometer per hour and 10 kilometers per hour. In an example embodiment, the value is 2 kilometers per hour.

In an example embodiment, the nominal creeping speed is a mathematical function of the calculated brake pedal activity. The functional dependence is that of a Step function.

in an example embodiment the calculated brake pedal activity is a class, assigned to a class of 5 comprising the brake activity, wherein the classes are subdivided between “do not activate brake” and “brake activated permanently” and the assignment is made owing to the intensity of the brake pedal activity. The new nominal creeping speed results from the current idling speed divided by the number of classes and multiplied by the allocated class, wherein the idling speed is the current idling rotations per minute converted into speed. In this manner, a Step function is obtained with discrete graduation of the new nominal creeping speed depending upon the calculated brake pedal activity.

Alternatively, in an example embodiment, the nominal creeping speed is a mathematical function of the calculated brake pedal activity. The functional dependence is linear.

In an example embodiment, a weighting factor results from the quotient of the calculated brake pedal activity and the maximum possible brake pedal activity during the period of measurement. The new nominal creeping speed results from the term (1—weighting factor) multiplied by the current idling speed, wherein the idling speed is the current rotations per minute converted into speed. In this manner, a linear correlation results between the calculated brake pedal activity and the new nominal creeping speed.

In an example embodiment, the period of measurement lies between 5 seconds and 30 minutes, In an example embodiment, the period is 5 minutes.

In an example embodiment, the nominal creeping speed is increased by a default increment value during the creeping process or during a transient interruption of the creeping process whilst actuating the accelerator pedal.

Alternatively, in an example embodiment, the nominal creeping speed is increased by a default increment value, when, after releasing the accelerator pedal, a renewed actuation of the accelerator pedal occurs within a default measuring-period during uninterrupted creeping process or during a transient interruption of the creeping process.

In an example embodiment, the accelerator pedal activity is calculated from the number of accelerator pedal actuations during a default measuring-period during an uninterrupted creeping process or during a transient interruption of the creeping process.

Alternatively, in an example embodiment, the accelerator pedal activity is the fraction of the time during which the accelerator pedal is actuated during a default measuring-period relative to the default measuring-period during an uninterrupted creeping process or during a transient interruption of the creeping process.

Alternatively, in an example embodiment, the accelerator pedal activity is calculated from a time integral versus the accelerator pedal angle or versus an averaged accelerator pedal angle or the additional engine torque required by the driver from the beginning to the end of a default measuring-period during an uninterrupted creeping process or during a transient interruption of the creeping process; thus, during an uninterrupted creeping process or only during a transient interruption of the creeping process.

In an example embodiment, the nominal creeping speed is increased by a default increment value weighted with the accelerator pedal activity.

In an example embodiment, he increment value lies between 0.01 kilometer per hour and 10 kilometers per hour. In an example embodiment, the value is 2 kilometers per hour.

In an example embodiment, the nominal creeping speed is a mathematical function of the calculated accelerator pedal activity. The functional dependence is that of a Step function.

In an example embodiment, the calculated accelerator pedal activity is a class, assigned to a class of five comprising the acceleration activity, wherein the classes are subdivided between “do not activate accelerator” and “accelerator activated permanently” and the assignment is made owing to the intensity of the accelerator pedal activity. The new nominal creeping speed results from the current idling speed divided by the number of classes and multiplied by the allocated class, wherein the idling speed is the current idling rotations per minute converted into speed. In this manner, a discrete graduation of the new nominal creeping speed is obtained depending upon the calculated accelerator pedal activity.

Alternatively, in an example embodiment, the nominal creeping speed is a mathematical function of the calculated accelerator pedal activity. The functional dependence is linear.

In an example embodiment, a weighting factor results from the quotient from a calculated accelerator pedal activity and the maximum possible accelerator pedal activity during the period of measurement. The new nominal creeping speed results from the term (1—weighting factor) multiplied by the current idling speed, wherein the idling speed is the current rotations per minute converted into speed. In this manner, a linear correlation results between the calculated brake pedal activity and the new nominal creeping speed.

In an example embodiment, the engine idling speed is increased such that after increasing the nominal creeping speed, the increased engine idling speed is higher by 20 to 50 rotations per minute than the converted increased nominal creeping speed in the transmission input rotation speed values. Alternatively, in an example embodiment, the nominal creeping speed is increased independently of the driver's activity, respectively starting slowly from the current nominal creeping speed versus the time.

In an example embodiment, the nominal creeping speed is thereby increased by 0.1 to 20 km/h per month. Alternatively, in an example embodiment, if the nominal creeping speed is increased once by 0.1 to 20 km/h starting from the current nominal creeping speed, when, in a period of 1 to 50 operating hours, for example, 2 operating hours of the vehicle, the creeping motion function is not activated.

In an example embodiment, the nominal creeping speed is set at a default value during the initial operation of the vehicle.

In an example embodiment, the default value is the default value of the nominal creeping speed during the initial operation of the vehicle.

In an example embodiment, the nominal creeping speed, in the presence of information regarding the road traffic, for instance, from a navigation system, is calculated from these pieces of information and is currently set at this value.

According to the invention, a computer program product is also proposed with a computer program that features the software means for executing a process mentioned above when the computer program is executed on a computer.

According to the invention, an apparatus is proposed for controlling the creeping process of a motor vehicle with a Control Unit, with an Automated Clutch and an automated transmission, with a creeping motion function for controlling the creeping process with a nominal creeping speed. The Control Unit is provided to decrease the nominal creeping speed during the creeping process or during a transient interruption of the creeping process depending on a brake pedal activity or to increase the nominal creeping speed during the creeping process or only during a transient interruption of the creeping process depending on an accelerator pedal activity.

Based on the process according to the invention and on the apparatus according to the invention the driver can therefore adapt the nominal creeping speed to the circumstances, so that after actuating the brake- or the accelerator pedal the nominal creeping speed and hence the actual creeping speed of the vehicle can be corrected downwards or upwards and finally, without further actuation of a pedal, the creeping process can be continued. Such an improvement in the default of the nominal creeping speed leads to a better adaptation to the driver's desire.

According to the invention, it is proposed to adapt the nominal creeping speeds when creeping at respective boundary conditions of the driving process. If the brake is activated anew after releasing the brake within a defined period, the nominal creeping speed for the next creeping process or for the continued creeping process is decreased. In addition, a measured value of the braking activity is calculated, for instance, the integral versus the braking torque or braking pressure. The associated nominal creeping speed is calculated discretely or continually depending upon the brake activity by means of appropriate mathematical methods. An alternative, for instance, is to subdivide the brake activity in five classes between “do not activate brake” and “brake pressed permanently” and to determine the nominal speed according to discrete or linear values between the idling speeds, converted into vehicle speed, and zero. If the driver now actuates the brake very frequently, the nominal creeping speed will be decreased accordingly.

Alternatively, a defined nominal creeping speed is specified during the first start or initial operation of the vehicle, based on “ignition on”, which is then decreased depending on the brake activity. Thus, in case of very frequent braking, the nominal creeping speed is decreased quickly.

The development of the nominal creeping speed could occur very slowly over the time or alternatively after a defined time in which the creeping motion did not occur or via the accelerator pedal.

For instance, if the creeping process is repeatedly interrupted by accelerating briefly, the nominal creeping speed will be increased. It is therefore proposed to determine the driver's desire to accelerate in the sense of the accelerator pedal activity as an integral versus accelerator angle or its mean value or alternatively via the additional engine torque required by the driver. Based on this desire to accelerate, the adaptation—thus increase—of the nominal rotation speed can occur, wherein also here a discrete or continuous subdivision takes place.

However, as soon as nominal rotation speeds are required to attain the nominal creeping speed, which lie above the normal idling rotation speed, a corresponding increase of the engine idling speed must be performed by the software. This increase of the idling rotation speed should take place such that the no Drive Train disturbance occurs. It is reasonable that the engine idling speed is at least higher by 20-50 rotations per minute than the required nominal speed calculated for the transmission input. If a reduction of the nominal creeping speed is required for the idling rotation speed that has been increased in this manner, then, first the idling rotation speed will be decreased again to the normal idling rotation speed before the slip is increased in order to attain a decrease in speed according to common creeping motion functions.

Alternatively, it would be possible to couple the acceleration activity with the gradient of the adaptive nominal creeping speed. A frequently actuated accelerator pedal would let the nominal creeping speed—for instance for the next creeping process—to rise more rapidly. In addition, here, in analogy with the brake pedal case, it is provided when starting the vehicle during the initial operation a definite nominal creeping speed is specified, which will then be adapted in further operation.

In many vehicles with automated transmission, the adaptation of gearshift points or defaults of the nominal transmission ratios are performed under the consideration of driver classification. In an example embodiment, this driver classification is used in a further embodiment of the invention likewise to take account of the nominal creeping speed during a creeping process. Therefore, a driver with a sporty driving style at high nominal creeping speeds is considered a normal driver.

In an example embodiment, it is intended that the nominal speed should be coupled with the information of road traffic—for instance, from a navigation system. It is advantageous, for instance, to perform an automatic shift to the next higher gear in the event of a high acceleration activity on motorways or expressways and hence attain a higher creeping speed instead of raising the engine rotation speed. To ensure that the speed change due to the gearshift is not too great, it is meant that the nominal creeping speed in the higher gear is lower than the one in the lower gear.

According to the invention, in an example embodiment, it is proposed that an optimum adaptation to the creeping speed be attained by performing appropriate evaluation of driver's profile or of driver's reaction. In that, both an adaptive increase as well as decrease of the nominal creeping speed will be attained.

### BRIEF DESCRIPTION OF THE SEVERAL VIEWS OF THE DRAWING

Further advantages and advantageous embodiments of the invention are subject of the following figures and description as well. The details are as follows:

FIG. 1 shows a schematic view of the process sequence according to the invention.

FIG. 2 shows a schematic depiction of interacting components.

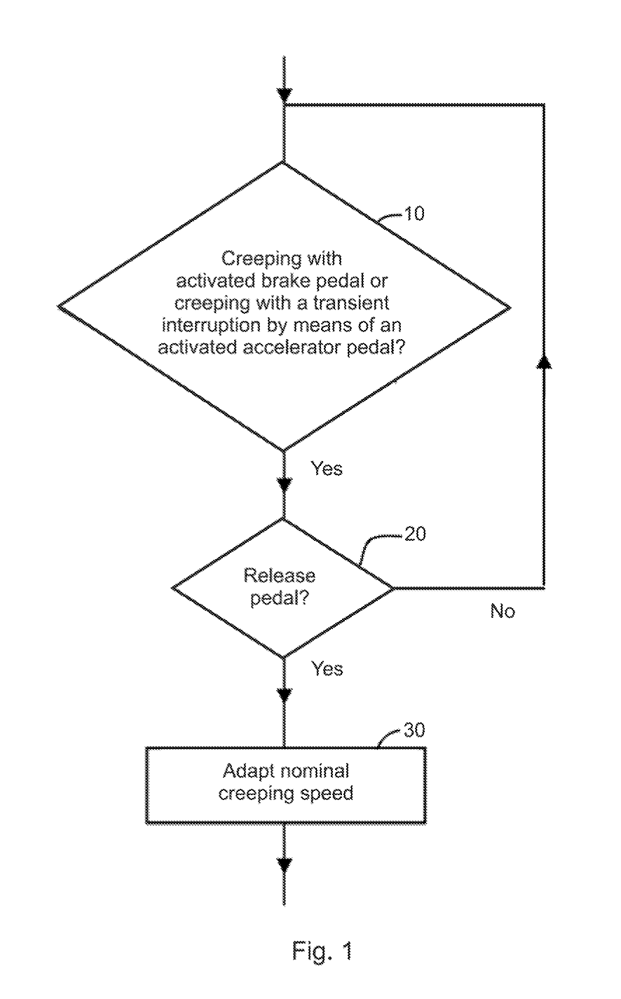

FIG. 1 depicts the schematic view of the process sequence according to the invention. In the creeping-process Query Step 10, it is verified whether a creeping process exists when the brake pedal is activated or a transient interruption of the creeping process exists by actuating the accelerator pedal.

### DETAILED DESCRIPTION OF THE INVENTION

In an example embodiment, if a creeping process is terminated by actuating the accelerator pedal, the subsequent time will be calculated until a creeping process is restored. In addition, in the Pedal Query Step 20 it will be checked whether the accelerator pedal was again released, thus, whether the pedal was released again. If not, a return is made to the creeping process Query Step 10 and the time since the beginning of the actuation of accelerator pedal will be determined.

In the creeping process Query Step 10, this time will be compared with a default period. If the calculated time is shorter than the default period, it will be evaluated as a transient interruption of the creeping process and a jump will be made to the Pedal Query Step 20. Should the calculated time exceed the default period, it will no longer be evaluated as a transient interruption of the creeping process and the process will begin anew. In an example embodiment, 1 minute is a default period. The period can also be selected between 1 second and 5 minutes.

If it has been established in the creeping process Query Step 10 that creeping motion with activated brake pedal or a transient interruption of the creeping process exists, then a jump will be made to the Pedal Query Step 20. Here, it will be determined whether the accelerator—or brake pedal is no longer activated—thus whether it has been released. If this is the case, a jump will be made to the Adaptation Step 30.

In the Adaptation Step 30, the nominal creeping speed will be decreased during actuation of the brake pedal determined in the creeping Query Step 10 and the release of the brake pedal determined in the Pedal Query Step 20. In the Adaptation Step 30, the nominal creeping speed will be increased during the actuation of accelerator pedal determined in the creeping Query Step 10 and the release of the brake pedal determined in the Pedal Query Step 20.

The process subsequently begins anew.

If the brake is subsequently activated again during the creeping process, and this is detected again during the creeping Query Step 10 and during the Pedal Query Step 20 and finally during the release of the brake pedal, then through the Pedal Query Step 20 a jump will not be made to the creeping Query Step 10 but rather to the Adaptation Step 30 and, there, the nominal creeping speed will be decreased further.

If the creeping process is subsequently interrupted for instance by actuating the accelerator pedal then in the creeping Query Step 10 the time since the beginning of the actuation of accelerator pedal will be determined and compared with the default period. If the time is still shorter than the period then it will be subsequently determined in the Pedal Query Step 20, whether or not the accelerator pedal has already been released again. If this is not the case, the time will be calculated again in the creeping Query Step 10 then compared, and so forth. This loop will be interrupted either in the creeping process Query Step 10 when the calculated time exceeds the default period so that the interruption of the creeping process is no longer evaluated as a transient and the process begins anew or in the Pedal Query Step 20, when it is determined that the accelerator pedal has been released again, wherein a jump is made to the Adaptation Step 30 and the nominal creeping speed is increased.

In an example embodiment, the nominal creeping speed is decreased respectively by a default reduction value or increased by a default increment value.

In an example embodiment, a preferred reduction value is 2 kilometers per hour. In an example embodiment, a value between 0.01 kilometer per hour and 10 kilometers per hour can be appropriate.

In an example embodiment, the increment value likewise is 2 kilometers per hour. A value between 0.01 kilometer per hour and 10 kilometers per hour can be appropriate.

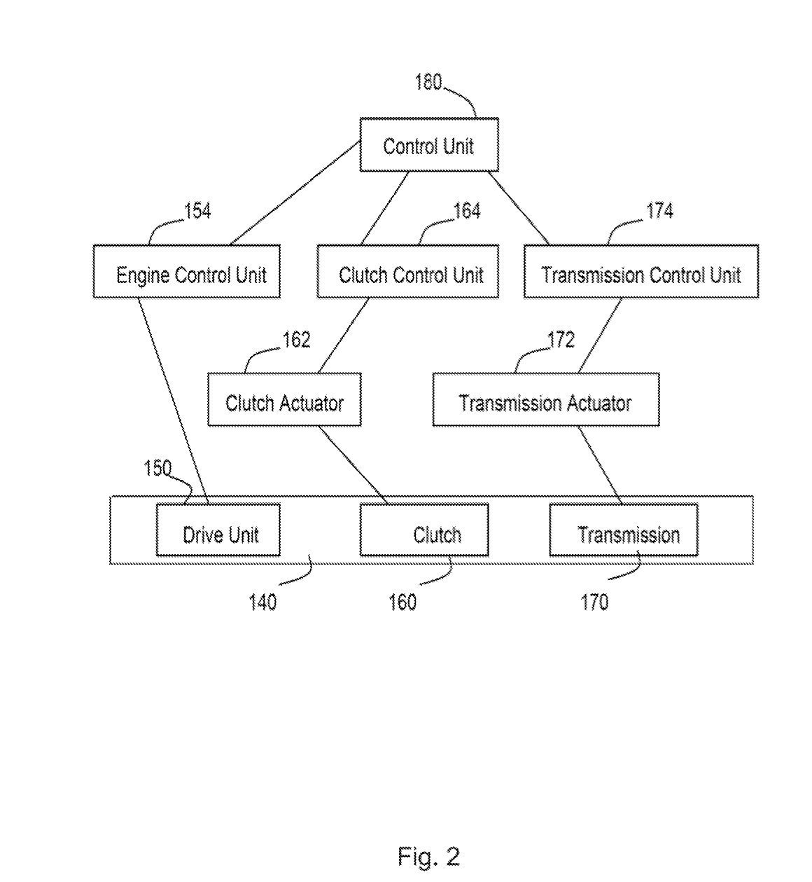

FIG. 2 schematically shows the interacting components of an apparatus that is suitable for executing the above-described process.

This apparatus serves for controlling the creeping process of a motor vehicle with a Control Unit 180, with an Automated Clutch 160, an Automated Transmission 170 with a creeping motion function for controlling the creeping process with a nominal creeping speed. The Control Unit 180 is provided to decrease the nominal creeping speed during the creeping process or during a transient interruption of the creeping process depending on a brake pedal activity or to increase the nominal creeping speed during the creeping process or only during a transient interruptions of the creeping process depending on a accelerator pedal activity. Creeping Query Step 10, Pedal Query Step 20 and Adaptation Step 30 can run inside the Control Unit 180. The activity of the accelerator pedal and of the brake pedal is detected by means of the sensors of a Control Unit 180, so that this information is at disposal.

An automated Transmission 170 features a plurality of transmission stages. Furthermore, an Automated Clutch 160 in the Drive Train 140 of the motor vehicle is disposed between a Drive Unit 150 and the Transmission 170. The Drive Unit 150 is controlled by means of an Engine Control Unit 154. The Clutch 160 is controlled by means of a Clutch Actuator 162 as an actuation means of the Clutch Control Unit 164. The transmission stages in the Transmission 170 are shifted by means of a Transmission Actuator 172 as actuation means of the Transmission 170 and the Transmission Actuator 172 is controlled by means of a Transmission Control Unit 174.

The transmission is depicted schematically in FIG. 2 and comprises all forms of twin clutch transmissions—also termed parallel shift transmission—which at least comprises two automated clutches and both of which are depicted schematically in the Automated Clutch 160, since apart from overlapping gearshifts normally only one clutch transmits torque but not both simultaneously.

The four Control Units 154, 164, 174 and 180 listed here as four separate control units due to their different functions, can obviously also be executed as a single control unit or can be subdivided into two or three control units.

### LIST OF REFERENCE SYMBOLS

10 Creeping Query Step
20 Pedal Query Step
30 Adaptation Step
140 Drive Train
150 Drive Unit
154 Engine Control Unit
160 Clutch
162 Clutch Actuator
164 Clutch Control Unit
170 Transmission
172 Transmission Actuator
174 Transmission Control Unit
180 Control Unit

What we claim is:

1. A process for controlling the creeping process of a motor vehicle with automated clutch and automated transmission, with creeping motion function for controlling the creeping process with nominal creeping speed, comprising decreasing a nominal creeping speed during the creeping process or during a transient interruption of the creeping process depending on brake pedal activity.

2. The process according to claim 1, further comprising increasing the nominal creeping speed during the creeping process or during the transient interruption of the creeping process depending on accelerator pedal activity.

3. The process according to claim 1, further comprising evaluating a period between 1 second and 5 minutes as the transient interruption.

4. The process according to claim 1 further comprising evaluating a period of 1 minute as the transient interruption.

5. The process according to claim 1, wherein the nominal creeping speed during the creeping process or during the transient interruption of the creeping process is decreased by actuating the brake by a default reduction value.

6. The process according to claim 5, wherein the nominal creeping speed is decreased by the default reducing value when after releasing the brake, renewed actuation of the brake occurs within a default measuring-period during an uninterrupted creeping process or during a transient interruption of the creeping process.

7. The process according to claim 1, wherein the brake pedal activity is calculated from the number of brake actuations during a default measuring-period, during an uninterrupted creeping process or during a transient interruption of the creeping process.

8. The process according to claim 7, wherein the brake pedal activity is a fraction of the time during which the brake is activated during the default measuring-period relative to the default measuring-period during uninterrupted creeping process or during the transient interruption of the creeping process.

9. The process according to claim 7, wherein the brake pedal activity is calculated from a time integral versus the brake torque or the brake pressure from the beginning to the end of the default measuring-period during the uninterrupted creeping process or during the transient interruption of the creeping process.

10. The process according to claim 1, wherein the nominal creeping speed is decreased by a default reduction value weighted with the brake pedal activity.

11. The process according to claim 10, wherein the reduction value lies between 0.01 kilometers per hour and 10 kilometers per hour.

12. The process according to claim 10, wherein the reduction value is 2 kilometers per hour.

13. The process according to claim 1, wherein the nominal creeping speed is a function of a calculated brake pedal activity and wherein the functional dependence is that of a step function.

14. The process according to claim 1, wherein the nominal creeping speed is a mathematical function of the calculated brake pedal activity, wherein the functional dependence is linear.

15. The process according to claim 1, wherein a period of measurement lies between 5 seconds and 30 minutes.

16. The process according to claim 1, wherein a period of measurement is 5 minutes.

17. The process according to claim 1, wherein the nominal creeping speed during the creeping process or during a transient interruption of the creeping process is increased by a default increment value.

18. The process according to claim 17, wherein the increment value lies between 0.01 kilometers per hour and 10 kilometers per hour.

19. The process according to claim 18, wherein the increment value is 2 kilometers per hour.

20. The process according to claim 1, further comprising increasing an engine idling speed such that after increasing the nominal creeping speed, the increased engine idling speed is higher by 20 to 50 rotations per minute than the increased nominal creeping speed converted into transmission input rotation speed.

21. The process according to claim 1, wherein the nominal creeping speed is increased independently of the driver's activity, respectively starting slowly from the current nominal creeping speed versus time.

22. The process according to claim 21, wherein the nominal creeping speed is increased by 0.1 to 20 km/h per month.

23. The process according to claim 22, wherein the nominal creeping speed is increased once by 0.1 to 20 km/h, starting from the current nominal creeping speed, when the creeping motion function is not activated in a period of 1 to 50 operating hours of the vehicle.

24. The process according to claim 1, wherein the nominal creeping speed is set at a default value during the initial operation of the vehicle.

25. The process according to claim 24, wherein the default value is the default value of the nominal creeping speed during the initial operation of the vehicle.

26. The process according to claim 1, wherein the nominal creeping speed, when information about the road traffic is available, for instance, from a navigation system, is calculated from such information and set currently at this value.

27. The process according to claim 1, wherein the nominal creeping speed is calculated based on a driver classification.

28. A computer-program product with a computer program that features software means for executing a process according to claim 1, wherein the computer program is executed on a computer.

29. An apparatus for controlling the creeping process of a motor vehicle with a control unit, an automated clutch and an automated transmission with a creeping motion function for controlling the creeping process with a nominal creeping speed, wherein the control unit is provided to decrease the nominal creeping speed during the creeping process or during a transient interruption of the creeping process depending on brake pedal activity or to increase the nominal creeping speed during the creeping process or only during a transient interruptions of the creeping process depending on accelerator pedal activity.
